(19) United States
(12) Patent Application Publication
(10) Pub. No.: US 2022/0358377 A1
(43) Pub. Date: Nov. 10, 2022

(54) MODEL BUILDING SYSTEM, QUALITY PREDICTION SYSTEM, AND QUALITY MANAGEMENT SYSTEM USING THE SAME

(71) Applicant: INSTITUTE FOR INFORMATION INDUSTRY, Taipei City (TW)

(72) Inventors: Cheng-Juei YU, Taipei City (TW); Chih-Hung LIAO, Taipei City (TW); Yi-Hsin WU, Taipei City (TW); Yi-Chun YAO, Taipei City (TW); Lin-Chun LU, Taipei City (TW); Juo-Yu WANG, Taipei City (TW)

(73) Assignee: INSTITUTE FOR INFORMATION INDUSTRY, Taipei City (TW)

(21) Appl. No.: 17/371,388

(22) Filed: Jul. 9, 2021

(30) Foreign Application Priority Data
May 10, 2021 (TW) 110116774

(51) Int. Cl. G06N 5/04; G06N 20/00

(52) U.S. Cl. CPC G06N 5/04; G06N 20/00

(57) ABSTRACT

A model building system, a quality prediction system, and a quality management system using the same are provided. The quality management system includes the quality prediction system, a measurement device, and a quality inspection device. The quality prediction system includes the model building system and a model application device. The model building system includes a data transformation device and a model training device. The data transformation device transforms raw measured data, including measurement properties of products, to sets of cluster data and multi-dimensional metadata corresponding to the measurement properties. The model training device creates a prediction model according to the cluster data, the quality inspection results, and the multi-dimensional metadata corresponding to a portion of the products, and then modifies structural parameters of the prediction model according to the raw measured data and the quality inspection results corresponding to the other portion of the products.

This application claims the benefit of Taiwan application Serial No. 110116774, filed May 10, 2021, the subject matter of which is incorporated herein by reference.

### BACKGROUND OF THE INVENTION

### Field of the Invention

The disclosure relates in general to a model building system, a quality prediction system, and a quality management system using the same, and more particularly to a model building system, a quality prediction system, and a quality management system capable of predicting product quality rapidly and accurately.

### Description of the Related Art

Nowadays, the manufacturing industry plays a very important role. The product quality determines the production cost and goodwill. Therefore, a manufacturer should pay more attention to product quality management. However, if all products are inspected before they leave the factory, the cost and time are more than expected. Therefore, how to simplify the quality examination without affecting the quality stability is a key issue.

### SUMMARY OF THE INVENTION

The disclosure is directed to a model building system, a quality prediction system, and a quality management system using the same, and particularly to a model building system, a quality prediction system, and a quality management system using a prediction model to predict the product quality.

According to a first aspect of the present disclosure, a model building system is provided. The model building system includes a data transformation device and a model training device. The data transformation device transforms M*N raw measured data consisting of N measurement properties of M products into N sets of cluster data and N-dimensional metadata corresponding to the N measurement properties. The M*N raw measured data include first raw measured data corresponding to a first portion of the M products and second raw measured data corresponding to a second portion of the M products. The N sets of cluster data include first cluster data corresponding to the first portion of the M products and second cluster data corresponding to the second portion of the M products. The M quality inspection results obtained by inspecting the M products include first quality inspection results corresponding to the first portion of the M products and second quality inspection results corresponding to the second portion of the M products. The model training device is electrically coupled to the data transformation device. The model training device creates a prediction model according to the second cluster data, the second quality inspection results, and the N-dimensional metadata. The model training device modifies structural parameters of the prediction model according to the first raw measured data and the first quality inspection results, wherein M and N are positive integers.

According to a second aspect of the present disclosure, a quality prediction system is provided. The quality prediction system includes a model building system and a model application device. The model building system receives M*N raw measured data consisting of N measurement properties of M products, and M quality inspection results corresponding to the M products. The model building system includes a data transformation device and a model training device. The data transformation device transforms the M*N raw measured data into N sets of cluster data and N-dimensional metadata corresponding to the N measurement properties. The M*N raw measured data include first raw measured data corresponding to a first portion of the M products and second raw measured data corresponding to a second portion of the M products. The N sets of cluster data include first cluster data corresponding to the first portion of the M products and second cluster data corresponding to the second portion of the M products. The M quality inspection results include first quality inspection results corresponding to the first portion of the M products and second quality inspection results corresponding to the second portion of the M products. The model training device is electrically coupled to the data transformation device. The model training device creates a prediction model according to the second cluster data, the second quality inspection results and the N-dimensional metadata. The model training device modifies structural parameters of the prediction model according to the first raw measured data and the first quality inspection results. The model application device is electrically coupled to the model building system. The model application device receives the prediction model and X*N raw measured data corresponding to X products and N measurement properties. The model application device receives the prediction model from the model training device after the prediction model is completely trained, and inputs the X*N raw measured data to the prediction model to generate X quality prediction results corresponding to the X products. M, N, and X are positive integers, and X is greater than M.

According to a third aspect of the present disclosure, a quality management system is provided. The quality management system includes at least one measurement device, a quality inspection device, and a quality prediction system. The at least one measurement device measures N measurement properties of M products to generate M*N raw measured data. The quality inspection device inspects the M products to generate M quality inspection results. The quality prediction system includes a model building system and a model application device. The model building system is electrically coupled to the at least one measurement device and the quality inspection device. The model building system receives the M*N raw measured data and the M quality inspection results. The model building system includes a data transformation device and a model training device. The data transformation device transforms the M*N raw measured data into N sets of cluster data and N-dimensional metadata corresponding to the N measurement properties. The M*N raw measured data include first raw measured data corresponding to a first portion of the M products and second raw measured data corresponding to a second portion of the M products. The N sets of cluster data include first cluster data corresponding to the first portion of the M products and second cluster data corresponding to the second portion of the M products. The M quality inspection results include first quality inspection results corresponding to the first portion of the M products and second quality inspection results corresponding to the second portion of the M products. The model training device is electrically coupled to the data transformation device. The model training device creates a prediction model according to the second cluster data, the second quality inspection results, and the N-dimensional metadata. The model training device modifies structural parameters of the prediction model according to the first raw measured data and the first quality inspection results. The model application device is electrically coupled to the at least one measurement device and the model building system. The model application device receives the prediction model from the model training device after the prediction model is completely trained, wherein M and N are positive integers.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram illustrating a quality management system according to an embodiment of the present disclosure.

FIG. 2 is a flowchart showing the operation of the quality prediction system.

FIG. 3 is a block diagram illustrating a model building system according to an embodiment of the present disclosure.

FIG. 4 is a flowchart showing the operation of the model building system.

FIG. 5 is a schematic diagram showing that the products PDT_M are divided into K sample sets provided for the model building system to evaluate the accuracy of the prediction model.

FIGS. 6A and 6B are flowcharts showing how the model building system evaluates the accuracy of the prediction model.

FIG. 7 is a schematic diagram showing the process of obtaining the range clusters ptfCLU of exemplified raw measured data on a one-by-one input basis.

FIG. 8 is a flowchart showing that the data transformation device 215 executes the process of obtaining the range clusters ptfCLU on the one-by-one input basis.

FIG. 9 is a schematic diagram showing the process of obtaining the range clusters ptfCLU of exemplified raw measured data on a batch input basis.

FIG. 10 is a flowchart showing that the data transformation device executes the process of obtaining the range clusters ptfCLU on the batch input basis.

FIG. 11A is a block diagram illustrating the model building system set up in a factory.

FIG. 11B is a block diagram illustrating the model building system having both in-factory arrangement and out-of-factory arrangement.

### DETAILED DESCRIPTION OF THE INVENTION

For a manufacturer, lots of products are produced and need to be measured or inspected. It is unrealistic to perform a full test for each product because it involves a much higher cost and longer time. If it is feasible to determine the product quality by measuring fewer properties selectively for different products, the inspection cost can be reduced without affecting the quality assurance.

The present disclosure provides a quality management system to reduce the cost of quality inspection. The quality management system has a quality prediction system that can generate a proper prediction model predMDL with respect to the manufacturing process of the products PDT. After the prediction model predMDL is fully trained, the manufacturer has to only measure the characteristics or properties of the products PDT_X during and/or after the manufacturing process. The raw measured data measDAT_X obtained from the measurement are inputted to the prediction model predMDL, and then the prediction model predMDL predicts the quality of the products PDT_X.

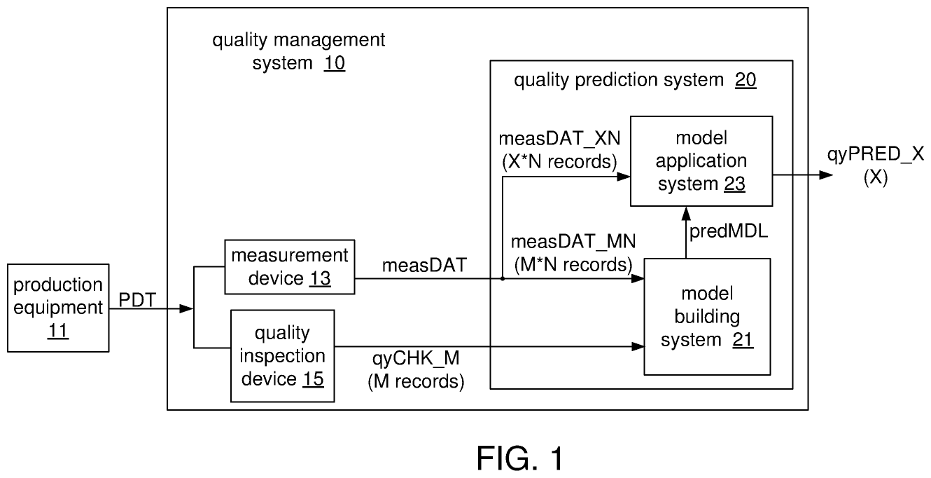

Please refer to FIG. 1, which is a block diagram illustrating a quality management system according to an embodiment of the present disclosure. The quality management system 10 includes a measurement device 13, a quality inspection device 15, and a quality prediction system 20. The quality prediction system 20 is used with a production equipment 11, the measurement device 13, and the quality inspection device 15. More than one measurement device 13 could be provided for measuring respective properties, functioning, or characteristics of the products PDT.

The products PDT manufactured from the production equipment 11 are classified into two categories. In one category, the products PDT_M (for example, 100,000 products PDT_M) are used for training the prediction model predMDL. On the other hand, the prediction model predMDL will predict the quality of the products PDT_X (for example, 1,000,000 products PDT_X) (that is, the other category). The products PDT_M are less than the products PDT_X because certain products PDT_M are enough to build the prediction model predMDL.

The quality prediction system 20 of the present disclosure builds the prediction model predMDL according to the raw measured data measDAT_MN and the quality inspection results qyCHK_M of the products PDT_M. Then, the same production equipment 11 is used to manufacture the products PDT_X. The quality prediction system 20 inputs the raw measured data measDAT_XN of the products PDT_X to the prediction model predMDL, and uses the prediction model predMDL to predict the quality of the products PDT_X. After building the prediction model predMDL of the present disclosure, the manufacturer can use the prediction model predMDL to directly predict the quality of the products PDT_X according to the raw measured data measDAT_XN without further quality inspection.

The products PDT (including products PDT_M and PDT_X) manufactured from the production equipment 11 are measured or tested by the measurement device 13. The measurement device 13 generates the raw measured data measDAT_MN of the products PDT_M and the raw measured data measDAT_XN of the products PDT_X. On the other hand, the quality inspection device 15 only inspects the quality of the products PDT_M to generate the quality inspection results qyCHK_M.

The quality prediction system 20 includes a model building system 21 and a model application system 23. The model building system 21 and the model application system 23 are electrically coupled to the measurement device 13, and receive the raw measured data measDAT (including raw measured data measDAT_MN of the products PDT_M and the raw measured data measDAT_XN of the products PDT_X) from the measurement device 13. On the other hand, the quality inspection device 15 is only electrically coupled to the model building system 21, not the model application system 23.

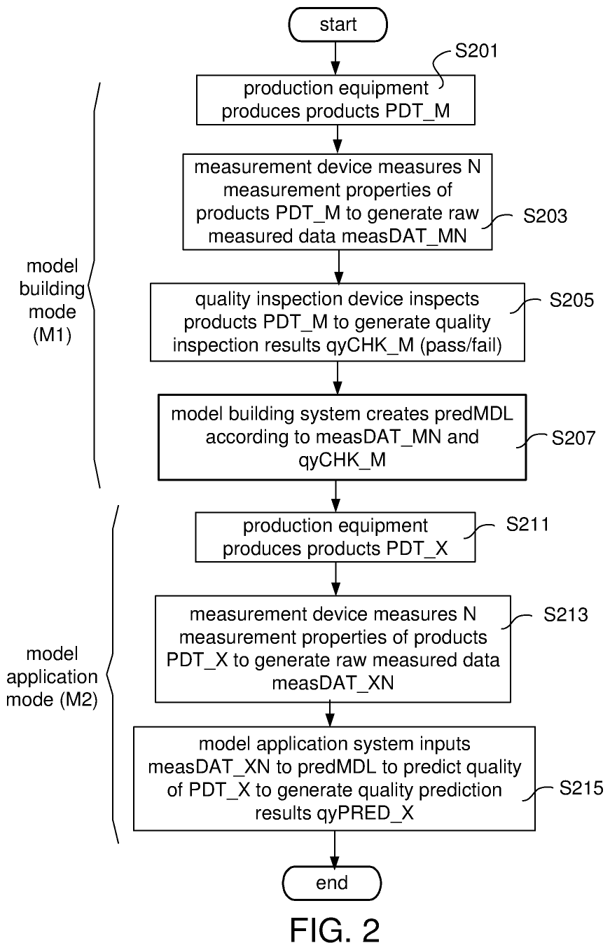

Please refer to FIG. 2, which is a flowchart showing the operation of the quality prediction system. Please refer to both FIG. 1 and FIG. 2 for further description. Briefly speaking, the quality prediction system 20 operates in two modes, that is, a model building mode M1 and a model application mode M2. In the model building mode M1, the model building system 21 creates the prediction model predMDL according to the raw measured data measDAT_MN and the quality inspection results qyCHK_M of the products PDT_M (steps S201, S203, S205, and S207). In the model application mode M2, the model application system 23 uses the prediction model predMDL to generate quality prediction results qyPRED_X according to the raw measured data measDAT_XN of the products PDT_X (steps S211, S213, and S215). The steps of the two modes of the quality prediction system 20 are given below.

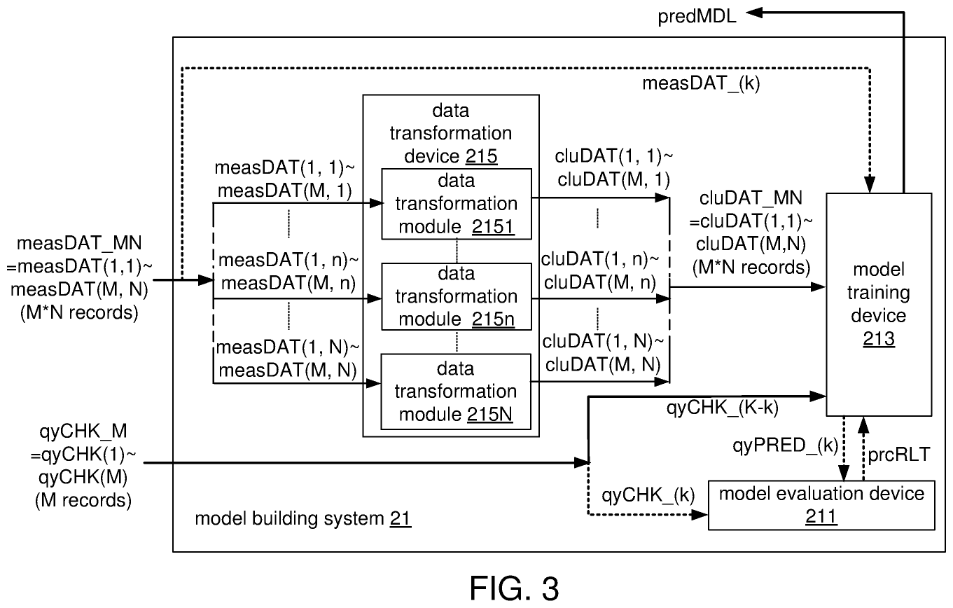

In the model building mode M1, the production equipment 11 produces the products PDT_M (step S201), and the measurement device 13 measures N properties of the products PDT_M (step S203). The measurement could be taken based on semi-finished products during the manufacturing process or taken based on finished products after the manufacturing process. Therefore, steps S201 and S203 could occur concurrently, alternately, or sequentially. Then, the quality inspection device 15 inspects the products PDT_M to generate the quality inspection results qyCHK_M of the products PDT_M (step S205). Afterward, the model building system 21 builds the raw measured data measDAT_MN and the quality inspection results qyCHK_M (step S207). FIGS. 3, 4, 5, 6A and 6B illustrate the details of step S207.

In the model application mode M2, the production equipment 11 produces the products PDT_X (step S211), and the measurement device 13 measures N properties of the products PDT_X to generate X*N raw measured data measDAT_XN (step S213). The model application system 23 inputs the raw measured data measDAT_XN to the prediction model predMDL, and the prediction model predMDL predicts the quality of the products PDT_X to generate the quality prediction results qyPRED_X (step S215). Subsequently, the manufacturer determines which of the products PDT_X are accepted or rejected according to the quality prediction results qyPRED_X.

In other words, once the model building system 21 has built the prediction model predMDL in the model building mode M1, the prediction model predMDL is provided for the model application system 23. Afterward, in the model application mode M2, the manufacturer needs not to use the quality inspection device 15 to inspect the quality of the products PDT_X, but uses the prediction model predMDL to directly predict the quality of the products PDT_X.

After the prediction model predMDL is built, the manufacturer can use the prediction model predMDL to predict the quality of the products PDT_X obtained in the subsequent manufacturing process. The quantities of the products PDT_X could vary in different manufacturing processes.

Furthermore, the manufacturer could perform a sampling inspection of the products PDT_X and compare the sampling inspection results and the quality prediction results qyPRED_X to determine whether the prediction model predMDL should be retrained or modified to maintain the applicability of the prediction model predMDL. If the sampling inspection result gives that the prediction model predMDL has unsatisfied accuracy and it is necessary to modify the parameters of the prediction model predMDL, the quality prediction system 20 returns to the step S201.

For illustration purposes, the products are integrated circuits (IC), the first measurement property is the low threshold of output voltage (mV), the second measurement property is the high threshold of output voltage (V), and the third measurement property is the electric current (nA) during a negative injection current test on the pins of the integrated circuit. After the quality inspection device 15 performs the quality inspection of the products PDT_M, the letter “T” denotes pass and the letter “F” denotes fail in the quality inspection results qyCHK_M.

For illustration purposes, ordered pairs are used to indicate the products 1˜M and the measurement properties 1˜N. For example, the raw measured data measDAT(m, n) represents the nth measurement property of the mth product. The raw measured data measDAT(m, n) will be transformed into cluster data CluDAT(m, n).

Table 1 gives an example of three measurement properties and the quality inspection results qyCHK_M of the products PDT_M.

TABLE 1

| | measDAT(m, 1) | measDAT(m, 2) | measDAT(m, 3) | |
|---|---|---|---|---|
| | m = 1~M | m = 1~M | m = 1~M | qyCHK(m) |
| Product | (property 1) | (property 2) | (property 3) | m = 1~M |
| 1 | measDAT(1, 1) = 5.840 | measDAT(1, 2) = 2.597 | measDAT(1, 3) = −9.683 | T |
| 2 | measDAT(2, 1) = 5.853 | measDAT(2, 2) = 2.601 | measDAT(2, 3) = −12.600 | T |
| 3 | measDAT(3, 1) = 5.954 | measDAT(3, 2) = 2.605 | measDAT(3, 3) = −1.145 | T |
| 4 | measDAT(4, 1) = 6.482 | measDAT(4, 2) = 2.596 | measDAT(4, 3) = −2.767 | F |
| 5 | measDAT(5, 1) = 5.914 | measDAT(5, 2) = 2.602 | measDAT(5, 3) = −7.378 | T |
| . . . | . . . | . . . | . . . | . . . |
| M | measDAT(M, 1) = 5.954 | measDAT(M, 2) = 2.602 | measDAT(M, 3) = −12.600 | T |

From Table1, each raw measured data measDAT_MN may contain a fractional part and is represented by a floating-point number. Lots of products PDT_M with many measurement properties require large storage space, great computation, and long processing time for a great deal of raw measured data measDAT_MN. To simplify the training and reduce the storage space, the model building system 21 of the present disclosure transforms the raw measured data measDAT_MN into cluster data cluDAT_MN and metadata metaDAT_N corresponding to the cluster data cluDAT_MN. Corresponding to N measurement properties, the data transformation device 215 will generate N-dimensional metadata metaDAT_N. In the specification, the cluster data cluDAT_MN are obtained by cluster definition and classification of the raw measured data measDAT_MN. The metadata metaDAT_N are statistical data of clusters related to respective measurement properties, for example, the maximum of the raw measured data of each cluster, the minimum of the raw measured data of each cluster, the accumulated summation of the raw measured data of each cluster, the count of the raw measured data of each cluster or the like.

In actual practice, the type and number of parameters used as the metadata metaDAT_N are not limited to the embodiments. Furthermore, the type and number of the metadata metaDAT_N may vary with the measurement properties. The steps of the cluster transformation, the criteria of the cluster transformation, the fields of the metadata metaDAT_N, and the recordation format of the metadata metaDAT_N after the cluster transformation are also adjustable to meet real requirements.

Subsequently, the model building system 21 uses the cluster data cluDAT_MN and the metadata metaDAT_N as the training basis of the prediction model predMDL and determines the structural parameters of the prediction model predMDL through artificial neural networks (ANNs) such as multilayer perceptron (MLP), convolutional neural network (CNN) or Oxford visual geometry group (VGG). The structural parameters may include the number of MLP layers, CNN layers, or nodes.

As described above, after the model building system 21 creates the prediction model predMDL in the model building mode M1, the prediction model predMDL is provided for the model application system 23. According to the embodiments of the present disclosure, the model building system 21 goes through three stages (that is, data transformation stage STG1, model training stage STG2, and model evaluation stage STG3) while building the prediction model predMDL. The model building procedure performs the data transformation stage STG1 once, and performs the model training stage STG2 and the model evaluation stage STG3 alternately till the accuracy of the prediction model predMDL reaches the predetermined threshold thPRED (for example, 99.5%). In actual practice, the threshold thPRED may be determined according to the manufacturing plan, product usage, or characteristics.

Please refer to FIG. 3, which is a block diagram illustrating a model building system according to an embodiment of the present disclosure. The model building system 21 includes a data transformation device 215, a model training device 213, and a model evaluation device 211. The data transformation device 215 is electrically coupled to the measurement device 13. The model training device 213 is electrically coupled to the measurement device 13, the model application system 23, the quality inspection device 15, the data transformation device 215, and the model evaluation device 211. The model evaluation device 211 is electrically coupled to the quality inspection device 15. In actual practice, the data transformation modules 2151, 215n, 215N, the data transformation device 215, the model training device 213, and the model evaluation device 211 can be implemented by software, hardware, or their combination. Further, the data transformation modules 2151, 215n, 215N could perform data transformation concurrently, sequentially, or overlappingly.

For illustration purposes, the arrows in FIG. 3 indicate the data flow. The solid arrows indicate the data flow in the model building system 21 during the data transformation stage STG1 and the model training stage STG2 of the prediction model predMDL. The dotted arrows indicate the data flow in the model building system 21 during the model evaluation stage STG3 of the prediction model predMDL.

The measurement device 13 measures N measurement properties of M products to generate raw measured data measDAT_MN. The data transformation modules 2151, 215n, 215N transform the raw measured data measDAT_MN into cluster data cluDAT_MN. Only three data transformation modules 2151, 215n, 215N are shown in the diagrams, but they are representative of N data transformation modules 2151-215N.

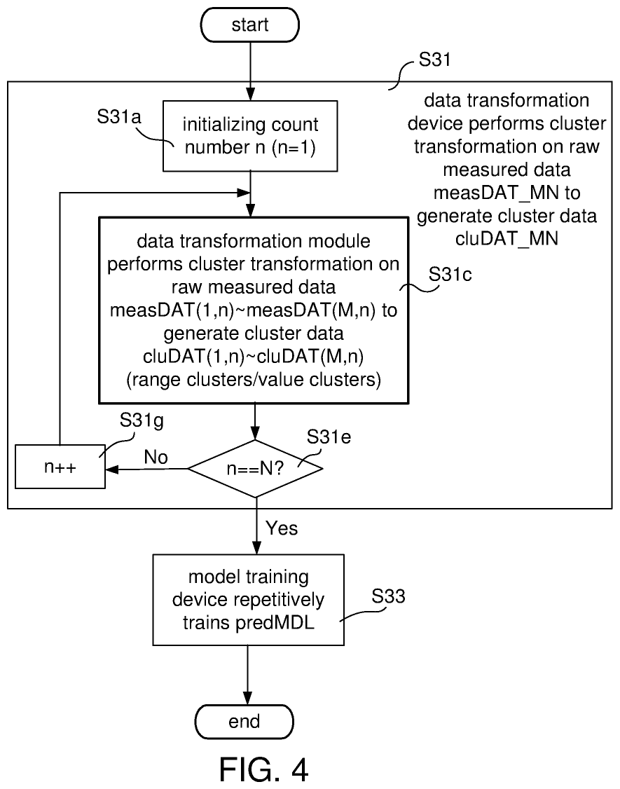

Please refer to FIG. 4, which is a flowchart showing the operation of the model building system. Please refer to both FIG. 3 and FIG. 4 with the following description.

In the data transformation stage STG1, the data transformation device 215 transforms the raw measured data measDAT_MN into the cluster data cluDAT_MN (step S31). The N data transformation modules 2151,215n, 215N of the data transformation device 215 perform cluster transformation regarding different measurement properties independently. The steps of performing cluster transformation on the raw measured data measDAT_MN corresponding to respective measurement properties to generate the cluster data cluDAT_MN and the metadata metaDAT_N (steps S31a, S31c, S31e, S31g) will be illustrated in the following description. After the cluster transformation, the data transformation device 215 transmits the cluster data cluDAT_MN to the model training device 213.

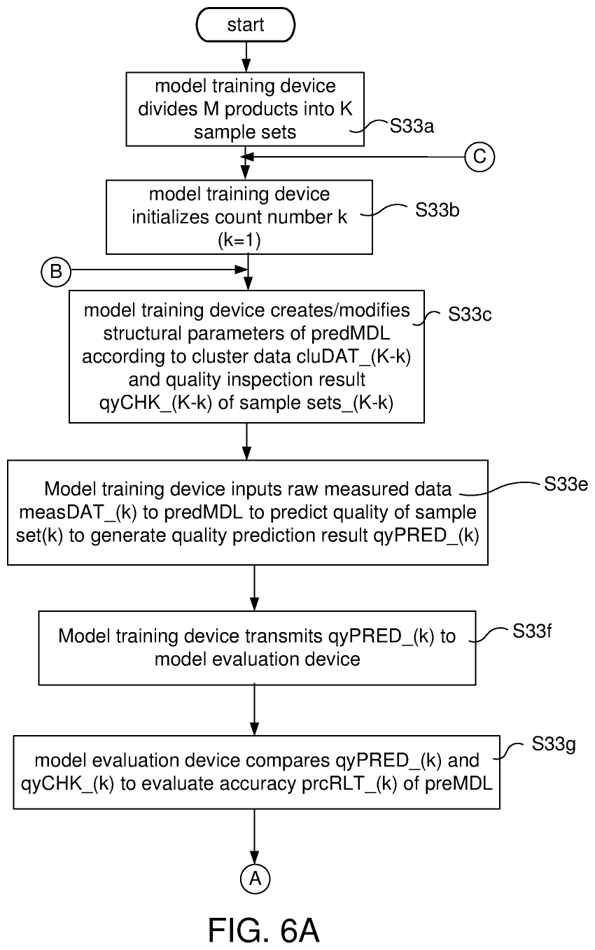

According to the present disclosure, the model training stage STG2 and the model evaluation stage STG3 of the prediction model predMDL are performed alternately in step S33. In this step, the model training device 213 trains the prediction model predMDL till the accuracy of the prediction model predMDL is satisfactory. Thus, the model training is finished. The details about step S33 will be described with reference to FIGS. 6A and 6B.

Step S31 is described with reference to both FIGS. 3 and 4. As shown in FIG. 3, the data transformation device 215 includes the data transformation modules 2151˜215N for performing cluster transformation on measurement properties 1˜N, respectively. At first, the count number n is initialized (n=1) (step S31a). Then, the data transformation modules 2151-215N performs the cluster transformation on the raw measured data measDAT(1, n)˜measDAT(M, n) to generate the cluster data cluDAT(1, n)˜cluDAT(M, n) (step S31c).

Subsequently, it is determined that whether all the N measurement properties have been subjected to cluster transformation (step S31e). If the determination result is “yes”, step S31 is finished; otherwise, the count number n counts up (n++) (step S31g) and the procedure returns to step S31c. The following description will give how to transform the raw measured data measDAT_MN into the cluster data cluDAT_MN in step S31c.

According to the present disclosure, the data transformation modules 2151˜215N perform the cluster transformation based on two rules. Firstly, the cluster data cluDAT_MN obtained from the cluster transformation require smaller storage space than the raw measured data measDAT_MN require. Secondly, the magnitude relationship between the cluster data cluDAT_MN truly reflects the magnitude relationship between the raw measured data measDAT_MN.

The present disclosure adopts cluster numbers instead of the values of the raw measured data measDAT_MN to meet the rules. Therefore, the storage space required for the cluster data cluDAT_MN is smaller than that required for the raw measured data measDAT_MN. The basic concept is that the raw measured data measDAT_MN represented in the form of floating-point numbers are transformed into the cluster numbers represented in the form of integers.

Please refer to Table 2 showing that the data transformation device 215 transforms the raw measured data measDAT_MN in Table 1 into the cluster numbers. The cluster numbers in Table 2 correspond to the measurement properties of products 1˜5. The procedure about transforming the raw measured data measDAT_MN into the cluster numbers is illustrated in embodiments below. Please refer to both Table 2 and Table 1 for the illustration.

TABLE 2

| | cluDAT(m, 1) | cluDAT(m, 2) | cluDAT(m, 3) |
|---|---|---|---|
| | m = 1~M | m = 1~M | m = 1~M |
| | corresponding | corresponding | corresponding |
| Product | to measurement | to measurement | to measurement |
| # | property 1 | property 2 | property 3 |
| 1 | cluDAT(1, 1) = 38 | cluDAT(1, 2) = 30 | cluDAT(1, 3) = 10 |
| 2 | cluDAT(2, 1) = 41 | cluDAT(2, 2) = 44 | cluDAT(2, 3) = 2 |
| 3 | cluDAT(3, 1) = 51 | cluDAT(3, 2) = 62 | cluDAT(3, 3) = 38 |
| 4 | cluDAT(4, 1) = 68 | cluDAT(4, 2) = 26 | cluDAT(4, 3) = 33 |
| 5 | cluDAT(5, 1) = 46 | cluDAT(5, 2) = 46 | cluDAT(5, 3) = 18 |
| . . . | . . . | . . . | . . . |
| M | cluDAT(M, 1) = 51 | cluDAT(M, 2) = 46 | cluDAT(M, 3) = 2 |

In the first column in Table 1 and Table 2, the raw measured data measDAT(1,1)˜measDAT(5,1) corresponding to the measurement property 1 of the products 1˜5 are arranged in ascending order to get the magnitude relationship as measDAT(1, 1)<measDAT(2, 1)<measDAT(5, 1)<measDAT(3, 1)<measDAT(4, 1). Also, the cluster numbers cluDAT(1, 1)˜cluDAT(5, 1) corresponding to the measurement property 1 of the products 1˜5 are arranged in ascending order to get the magnitude relationship as cluDAT(1, 1)<cluDAT(2, 1)<cluDAT(5, 1)<cluDAT(3, 1)<cluDAT(4, 1).

Therefore, the raw measured data measDAT(1, 1)˜measDAT(5, 1) of the products 1˜5 have a similar magnitude relationship to the cluster data cluDAT(1, 1)μcluDAT(5, 1) of the products 1˜5. In other words, the sequence of the sorted cluster numbers corresponding to the products 1˜5 reflects the sequence of the sorted raw measured data corresponding to the products 1˜5. Although only five products are involved in the example to explain the magnitude relationship, the principle can be extended to any number of products.

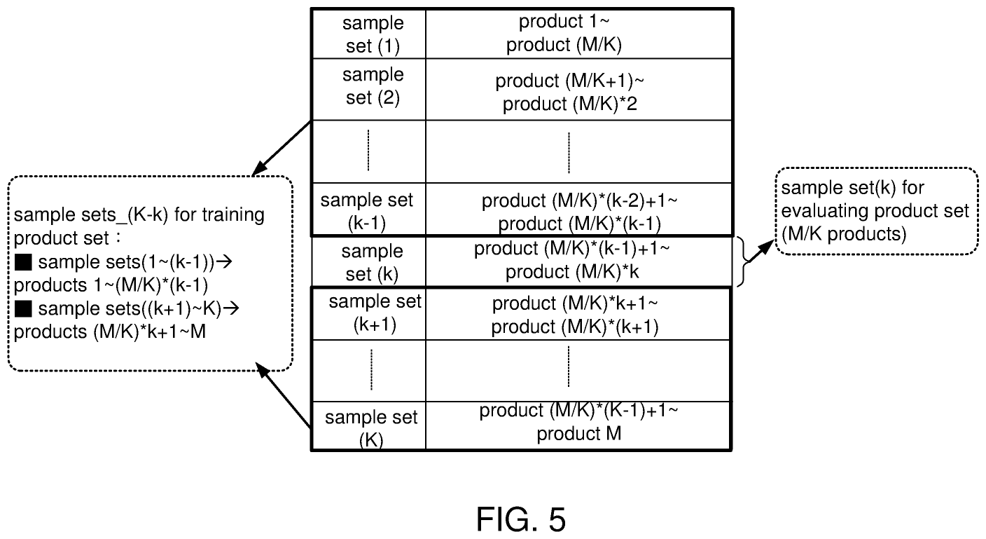

The data transformation device 215 performs the cluster transformation to transform the raw measured data measDAT_MN into the cluster data cluDAT_MN. Each of the model training device 213 and the model evaluation device 211 does not use all of the cluster data cluDAT_MN at one time to train the prediction model predMDL or evaluate the accuracy of the prediction model predMDL. According to the concept of the present disclosure, the model training device 213 sequentially selects some of the products PDT_M and uses corresponding cluster data cluDAT_(K−k) to train the prediction model predMDL. The model evaluation device 211 sequentially selects the other products and uses the corresponding raw measured data measDAT_(k) to evaluate the accuracy of the prediction model predMDL. FIG. 5 shows how to select the products from the products PDT_M to train and evaluate the prediction model predMDL, respectively.

Please refer to FIG. 5, which is a schematic diagram showing that the products PDT_M are divided into K sample sets provided for the model building system to evaluate the accuracy of the prediction model predMDL. The model training device 213 divides the M products into K sample sets, wherein M is a multiple of K. The products correspond to the first to Kth sample sets are shown in FIG. 5. For example, if M=100,000 and K=10, the first sample set corresponds to the products 1˜10,000, the Kth sample set corresponds to the products 90,000˜100,000, and so forth.

According to the concept of the present disclosure, the sample sets 1˜K are divided into two product sets: an evaluation product set including the kth sample set having M/K products, and a training product set includes the sample sets (K-k) having (K−1)*M/K products. The sample sets (K-k) in the description are defined as the products other than the kth sample set. Therefore, the sample sets (K-k) include the first to (k−1)th sample sets and the (k+1)th˜Kth sample sets, that is, products 1˜(M/K)*(k−1) and products (M/K)*k+1˜M.

According to the concept of the present disclosure, the model training device 213 uses the cluster data cluDAT_(K-k) and the quality inspection results qyCHK_(K-k) corresponding to the products in the sample sets (K-k) (that is, the training product set) to train the prediction model predMDL. Please see Table 3 which shows the data taken by the model building system 213 to train the prediction model predMDL.

TABLE 3

| Products of sample sets | | |
|---|---|---|
| (K − k) | cluDAT_(K − k) | qyCHK_(K − k) |
| Products 1~(M/K)*(k − 1) | cluDAT(1, 1~N)~cluDAT((M/K)*(k − 1) + 1, 1~N) | qyCHK(1 )~qyCHK ((M/K)*(k − 1)) |
| Products (M/K)*k + 1~M | cluDAT((M/K)*k + 1, 1~N)~cluDAT(M, 1~N) | qyCHK ((M/K)*k + 1)~qyCHK(M) |

According to the concept of the present disclosure, the model training device 213 and the model evaluation device 211 use the raw measured data measDAT_(k) and the quality inspection result qyCHK_(k) of the products included in the kth sample set (that is, the evaluation product set) to evaluate the accuracy of the prediction model predMDL (Table 4). Please see Table 4 showing the raw measured data measDAT_(k) and the quality inspection result qyCHK_(k) used for estimating the accuracy of the prediction model predMDL.

TABLE 4

| Products of kth sample set | measDAT_(k) | qyCHK_(k) |
|---|---|---|
| Products | measDAT((M/K)*(k − 1 ) + 1, 1~N)~measDAT((M/K)*k, 1~N) | qyCHK((M/K)*(k − 1) + 1)~qyCHK((M/K)*k) |
| (M/K)*(k − 1) + 1~(M/K)*k | | |

According to the concept of the present disclosure, the model training device 213 sets the variable k to be 1-K sequentially while training the prediction model predMDL. That is to say, for creating the prediction model predMDL, (M/K) products included in each sample set 1-K will be sequentially used for model training and model evaluation. FIG. 5 shows that the cluster data cluDAT_(K-k) are selected for training the prediction model predMDL and the raw measured data measDAT_(k) are selected for evaluating the accuracy of the prediction model predMDL. Next, the description with reference to FIGS. 5, 6A, and 6B will show how the data transformation device 215 generates the cluster data cluDAT_MN and the metadata metaDAT_N.

Please refer to FIGS. 6A and 6B, which are flowcharts showing that the model building system selects the cluster data and the quality inspection results to perform the model training and selects the raw measured data and the quality inspection result to evaluate the accuracy of the prediction model.

At first, the model training device 213 divides the M products into K sample sets (step 33a). Therefore, each sample set corresponds to M/K products. Then, the model training device 213 initializes the data combination count number k (k=1) (step S33b). The model training device 213 uses the cluster data cluDAT_(K-k) and the quality inspection result qyCHK_(K-k) corresponding to the (K−1)*M/K products included in the sample sets (K-k), that is, the training product set in Table 3, to create and/or modify the structural parameters of the prediction model predMDL (step S33c).

After the model training device 213 creates and/or modifies the structural parameters of the prediction model predMDL, the model evaluation device 211 inputs the raw measured data measDAT_(k) corresponding to the M/K products included in the kth sample sets, that is, the evaluation product set in Table 4, to the prediction model predMDL. Then, the model training device 213 uses the prediction model predMDL to generate the quality prediction result qyPRED_(k) corresponding to the M/K products included in the kth sample set (step S33e). Meanwhile, the model training device 213 transmits the quality prediction result qyPRED_(k) corresponding to the M/K products included in the kth sample set to the model evaluation device 211 (step S33f).

The model evaluation device 211 compares the quality prediction result qyPRED_(k) and the quality inspection result qyCHK_(k) corresponding to the products of the kth sample set to evaluate the accuracy prcRLT_(k) of the quality prediction result qyPRED_(k) generated by the prediction model predMDL. The accuracy prcRLT_(k) of the quality prediction result qyPRED_(k) is defined as the similarity between the quality prediction result qyPRED_(k) and the quality inspection result qyCHK_(k) (step S33g) wherein the quality prediction result qyPRED_(k) corresponding to the products in the kth sample set is generated by the prediction model predMDL, and the quality inspection result qyCHK_(k) is generated by the quality inspection device 15.

Focusing on the kth sample set, if the quality prediction result qyPRED_(k) and the quality inspection result qyCHK_(k) match (for example, the quality prediction result qyPRED_(k) and the quality inspection result qyCHK_(k) indicate the same quality result, that is, pass or fail) for more products, it means that the prediction model predMDL has higher accuracy prcRLT_(k). Otherwise, if the quality prediction result qyPRED_(k) and the quality inspection result qyCHK_(k) do not match (for example, the quality prediction result qyPRED_(k) and the quality inspection result qyCHK_(k) indicate different quality result, that is, pass vs. fail) for more products, it means that the prediction model predMDL has lower accuracy prcRLT_(k).

Subsequently, it is determined whether the accuracy prcRLT_(k) of the prediction model predMDL performing the quality prediction of the products in the kth sample set achieves a predetermined accuracy threshold thPRED, and an accuracy result is generated (step S33i). If the determination result (accuracy result) of step S33i is “no”, the model evaluation device 211 informs the model building system 213 that the accuracy prcRLT_(k) of the current prediction model predMDL does not meet the requirement. Thus, the model training device 213 has to modify the structural parameters of the prediction model predMDL (step S33o) and perform step S33b again. It is to be noted that modifying the structural parameters of the prediction model predMDL may cover changing the architecture of the prediction model predMDL, for example, changing from the CNN architecture into the MLP architecture. The details about selecting the architecture of the prediction model predMDL and selecting/modifying the structural parameters are not given herein.

If the determination result (accuracy result) of step S33i is “yes”, the model evaluation device 211 further checks whether all of the sample sets 1˜K have been selected for the evaluation sequentially (k=K?) (step S33k). If not, the data combination count number k counts up (k++) (step S33m) and the procedure goes back to step S33c. If it is determined “yes” in step S33k, the model evaluation device 211 informs the model training device 213 that the accuracy prcRLT_( )˜prcRLT_(K) of the current prediction model predMDL is sufficient to finish training the prediction model predMDL. At this time the model training device 213 transmits the structural parameters of the prediction model predMDL to the model application system 23. Afterward, the model application system 23 uses the structural parameters of the prediction model predMDL and the raw measured data measDAT_XN of the products PDT_X to predict the quality of the products PDT_X.

According to the concept of the present disclosure, the cluster data cluDAT_MN obtained from the cluster transformation could be used instead of the raw measured data measDAT_MN to train the prediction model predMDL and evaluate the accuracy of the prediction model predMDL. The cluster data cluDAT_MN obtained from the cluster transformation requires a much smaller storage space while maintaining the statistical characteristics of the raw measured data measDAT_MN. In addition, the use of the metadata metaDAT_N in connection with the cluster data cluDAT_MN can ensure sufficient statistical information during model training to generate a well-trained prediction model predMDL.

According to the concept of the present disclosure, the cluster transformation regarding different measurement properties is independently and separately performed. The present disclosure provides two types of cluster transformation to provide the cluster data cluDAT_MN which can reflect the magnitude relationship between the raw measured data measDAT_MN. One is range transformation based on value ranges, and the other is value transformation based on values of the raw measured data. Also, there are two types of input basis, that is, one-by-one input basis and batch input basis.

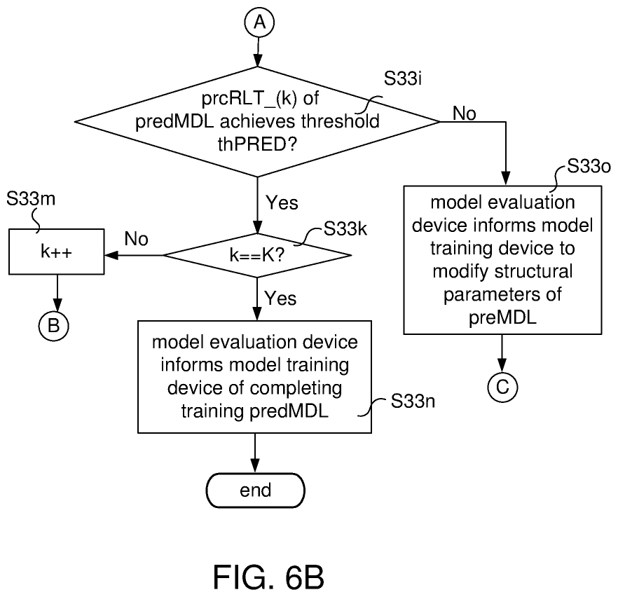

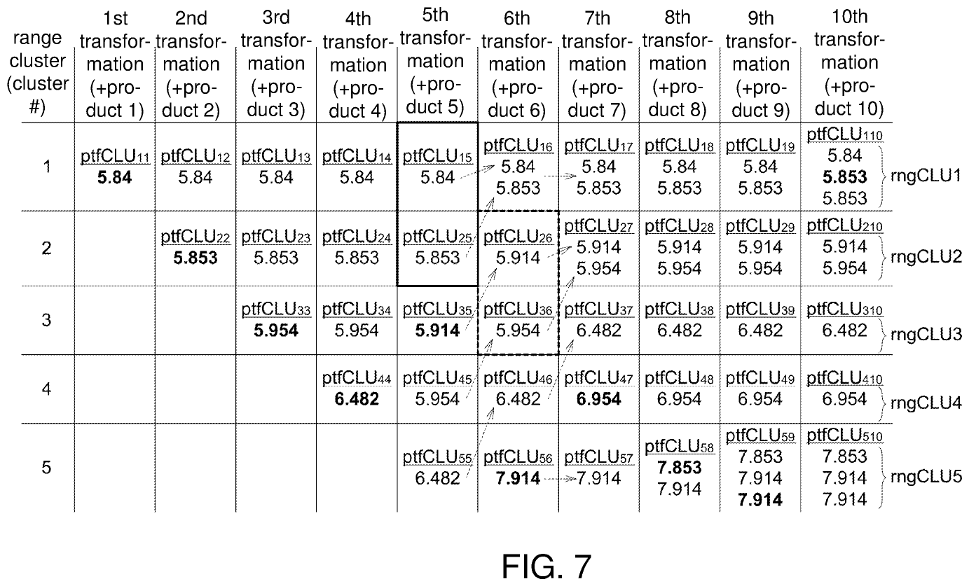

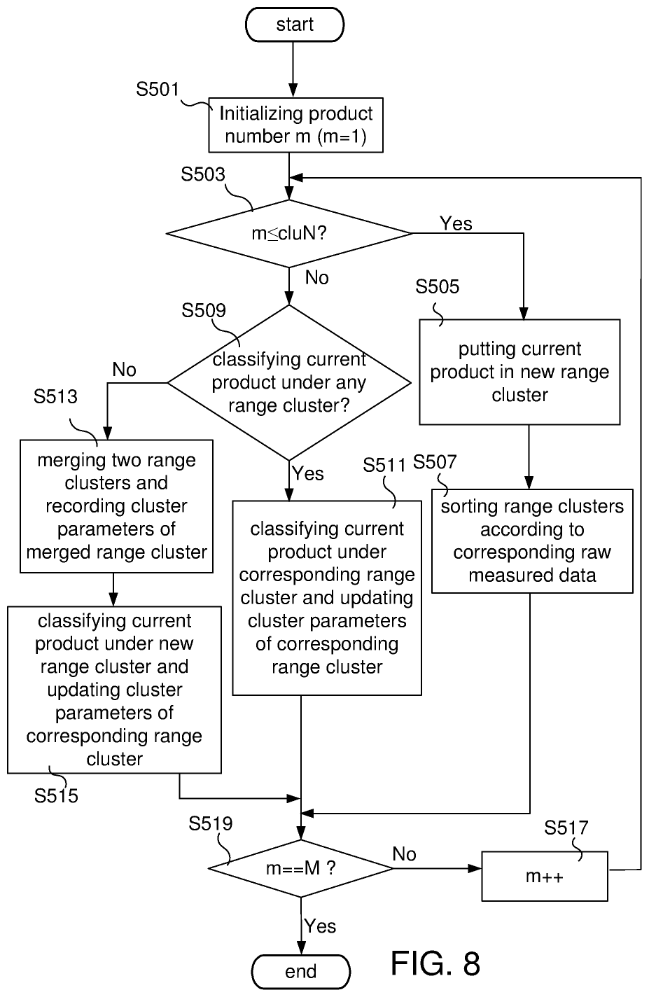

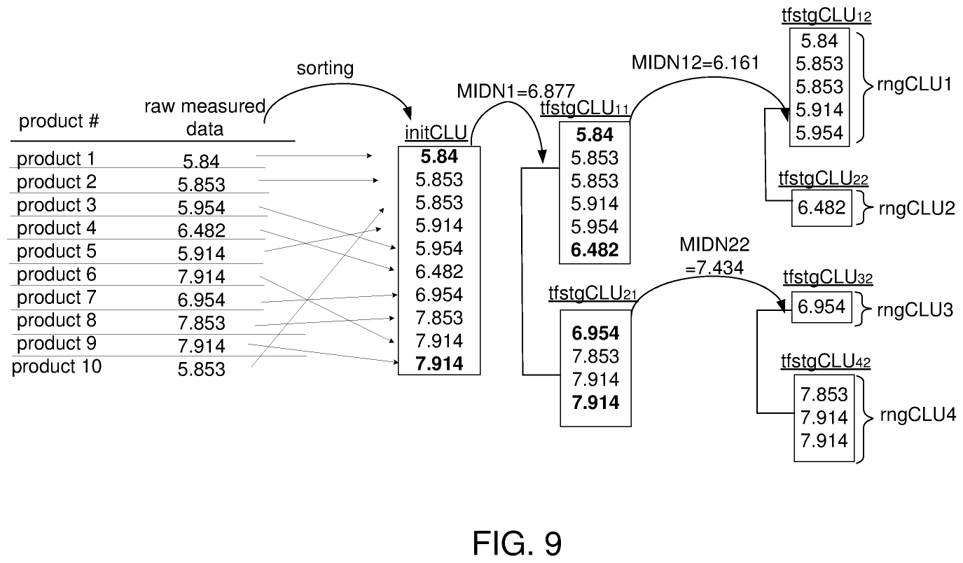

The range transformation divides the raw measured data measDAT(1, n)˜measDAT(M, n) into value ranges, and the value ranges are sorted. The sorted value ranges are used instead of the values of the raw measured data. Each value range defines a range cluster rngCLU. That is to say, in the range transformation, each range cluster rngCLU corresponds to a value range, and the value range covers multiple values of the raw measured data. This type of transformation groups certain value in a value range and uses the cluster number of the value range instead of the raw measured data. This cluster transformation merges some values of the raw measured data and causes certain distortion. FIGS. 7 and 8 illustrate the cluster transformation based on value ranges. Also, FIGS. 9 and 10 illustrate another cluster transformation based on value ranges.

On the other hand, the value transformation treats each record of the raw measured data as a cluster. Even though the values in the raw measured data corresponding to different products are slightly different, they are still treated as different value clusters valCLU. The cluster transformation based on the raw measured data keeps each value of the raw measured data. Therefore, no distortion occurs on the cluster data obtained from the value transformation. Tables 10˜13 show the value transformation.

In the two types of cluster transformation, the cluster numbers are determined and sorted according to the raw measured data measDAT(1˜M, n) no matter which of the range clusters rngCLU or the value clusters valCLU are adopted. Therefore, when the raw measured data measDAT(1˜M, n) of the products are transformed into the cluster data cluDAT(1˜M, n) represented by the cluster numbers, the magnitude relationship between the cluster numbers can reflect the magnitude relationship between the raw measured data measDAT(1˜M, n). Accordingly, using the cluster numbers to train the prediction model predMDL can truly reflect the relevance between the manufacturing process of the products PDT_M and the raw measured data measDAT(1˜M, n).

As described above, in actual practice, M and N are large numbers. For illustrating the cluster transformation for generating the cluster data, only a small number of records of raw measured data (M=10) are given in the example. The steps of generating the cluster data corresponding to other measurement properties and the corresponding metadata and their data format can be derived from the description of the present disclosure without further explanation. It is to be noted that the cluster transformation of different measurement properties (n=1˜N) is performed independently. The following description will focus on the raw measured data measDAT(1˜M, n) corresponding to the nth measurement property. In actual practice, the cluster transformation can be applied to any raw measured data involving other measurement properties, other value ranges, or other sample sizes.

Please refer to Table 5, giving the raw measured data including measurement property 1 of ten products (m=1˜10).

TABLE 5

| Product(m) | measDAT(m, 1) |
|---|---|
| 1 | 5.840 |
| 2 | 5.853 |
| 3 | 5.954 |
| 4 | 6.482 |
| 5 | 5.914 |
| 6 | 7.914 |
| 7 | 6.954 |
| 8 | 7.853 |
| 9 | 7.914 |
| 10 | 5.853 |

FIGS. 7 and 8 illustrate the process of transforming the raw measured data into the range clusters rngCLU on a one-by-one input basis. The one-by-one input basis in the present disclosure means that the process receives only one record of raw measured data measDAT(m, n) corresponding to one product every time. Therefore, the measurement property of the ten products listed in Table 5 will be input and transformed individually in ten non-overlapping steps. The total number of the range cluster rngCLU should be preset according to the storage space of the model building system 21, the processing speed of the model training device 213, the product characteristics, etc.

Please refer to FIG. 7, which is a schematic diagram showing the process of obtaining the range clusters rngCLU through a one-by-one transformation based on the raw measured data in Table 5. In FIG. 7, the values in bold type represent the currently-inputted raw measured data measDAT(m, n), the row title represents the cluster number of the range cluster ptfCLU in each transformation, and the column title represents the product number corresponding to the raw measured data measDAT(m, n) received in each transformation. The position of the raw measured data in the table may vary so as to correspond to different range cluster ptfCLU numbers during the one-by-one transformation. For illustration purposes, five clusters (total cluster number cluN=5) are given in the example. After the data corresponding to all of the M products are inputted and transformed, the range clusters ptfCLU obtained in the last transformation are defined as the range clusters rngCLU.

Before receiving the raw measured data measDAT(1, n)=5.84 of the product 1, no range cluster ptfCLU has been defined. Therefore, in the first transformation, the raw measured data measDAT(1, n)=5.84 is classified in the range cluster (ptfCLU₁₁) associated with cluster number 1. After the first transformation, only the range cluster (ptfCLU₁₁) associated with the cluster number 1 is occupied. Similarly, through the second to the fifth transformation, the raw measured data measDAT(2, n)˜measDAT(5, n) are sorted to be classified in respective range clusters. After the fifth transformation, the range cluster (ptfCLU₁₅={5.84}) associated with the cluster number 1, the range cluster (ptfCLU₂₅={5.853}) associated with the cluster number 2, the range cluster (ptfCLU₃₅={5.914}) associated with the cluster number 3, the range cluster (ptfCLU₄₅={5.954} associated with the cluster number 4, and the range cluster (ptfCLU₅₅={6.482}) associated with the cluster number 5 are all used.

At this time, the number of the range clusters rngCLU has reached the total cluster number cluN, and the newly-inputted raw measured data can not directly occupy a new sample cluster ptfCLU in the later transformation. Therefore, the procedure needs to judge which one of the five range clusters ptfCLU is proper for accepting the new raw measured data. If the value range corresponding to one range cluster ptfCLU covers the current raw measured data, the current raw measured data can be classified under the range cluster ptfCLU. If the value ranges of the five range clusters ptfCLU do not well cover the current raw measured data, the value ranges of the range clusters ptfCLU will be adjusted.

In the sixth transformation, since the number of the range clusters rngCLU has reached the total cluster number cluN in the previous transformation, no additional range cluster rngCLU can be provided for the raw measured data measDAT(6, n)=7.914 of the product 6. Therefore, the procedure needs to determine which one of the five range clusters (ptfCLU₁₅, ptfCLU₂₅, ptfCLU₃₅, ptfCLU₄₅, ptfCLU₅₅) has a proper value range to contain the raw measured data measDAT(6, n)=7.914 of the product 6. It can be seen that the raw measured data measDAT(6, n)=7.914 of the product 6 is larger than the previous raw measured data. Thus, it is considered whether to classify the raw measured data measDAT(6, n)=7.914 of the product 6 in the range cluster (ptfCLU₅₅) associated with the cluster number 5 or not. However, the difference between the raw measured data measDAT(6, n)=7.914 of the product 6 and the value (6.482) in the range cluster (ptfCLU₅₅) is 1.432 (7.914−6.482=1.432), greater than the difference between any two adjacent range clusters. The difference between the range clusters ptfCLU₁₅ and ptfCLU₂₅ is 0.013; the difference between the range clusters ptfCLU₂₅ and ptfCLU₃₅ is 0.061; the difference between the range clusters ptfCLU₃₅ and ptfCLU₄₅ is 0.04; and the difference between the range clusters ptfCLU₄₅ and ptfCLU₅₅ is 0.528. Accordingly, it is improper to classify the raw measured data (7.914) of the product 6 in any of the existing range clusters ptfCLU₁₅-ptfCLU₅₅.

Therefore, a range cluster should be exclusive to the raw measured data measDAT(6, n)=7.914 of the product 6. Because of the restriction on the total cluster number cluN, two range clusters of the range clusters ptfCLU₁₅-ptfCLU₅₅ will be merged to empty a range cluster for the raw measured data measDAT(6, n). Observing the differences (0.013, 0.061, 0.04, 0.528) between any two adjacent range clusters ptfCLU₁₅˜ptfCLU₅₅, it is found that the smallest difference (0.013) is located between the range clusters ptfCLU₁₅ and ptfCLU₂₅. Hence, in the sixth transformation, the range clusters ptfCLU₁₅, ptfCLU₂₅ are selected and merged into the range cluster ptfCLU₁₆. The merged range cluster ptfCLU₁₆ corresponds to a value range of 5.84˜5.853. Then, the raw measured data measDAT(6, n)=7.914 of the product 6 is classified in the range cluster ptfCLU₅₆. Besides, the range clusters ptfCLU₂₆, ptfCLU₃₆, ptfCLU₄₆ come from the range clusters ptfCLU₃₅, ptfCLU₄₅, ptfCLU₅₅, respectively.

In the one-by-one transformation, the correspondence between the raw measured data and the range clusters ptfCLU₁₅-ptfCLU₅₅ are adjusted to generate new correspondence between the raw measured data and the range clusters ptfCLU₁₆-ptfCLU₅₆. The adjustment is indicated by dotted arrows in FIG. 7. After the sixth transformation, the range clusters including ptfCLU₁₆={5.84, 5.853}, ptfCLU₂₆={5.914}, ptfCLU₃₆={5.954}, ptfCLU₄₆={6.482}, and ptfCLU₅₆={7.914} are formed.

The related concept and range adjustment in the seventh to the tenth transformation can be derived from the above description, and detailed derivation is not given herein. The range clusters ptfCLU₁₁₀˜ptfCLU₅₁₀ obtained after the tenth transformation are called the range clusters rngCLU1˜rngCLU5.

Basically, the transformation includes selecting the best range cluster ptfCLU to cover the newly-inputted raw measured data measDAT(m, n) of the product(m) according to the differences between the range clusters ptfCLU. The steps of calculating the differences between the range clusters ptfCLU, calculating the differences between the raw measured data measDAT(m, n) and the range clusters ptfCLU, and determining the range cluster ptfCLU for the raw measured data measDAT(m, n) are not given again.

As shown in FIG. 7, when the number of inputted raw measured data does not exceed the preset total cluster number cluN, the raw measured data are directly classified in the corresponding range clusters ptfCLU. When the number of inputted raw measured data exceeds the preset total cluster number cluN, the currently-inputted raw measured data measDAT(m, n) is classified under a corresponding range cluster ptfCLU, and the information of the range clusters ptfCLU are modified dynamically in each transformation, for example, the value ranges, the input record number of the raw measured data and the cluster parameters of the range clusters ptfCLU. It is possible that some raw measured data belong to one range cluster ptfCLU in the current transformation but belong to another range cluster ptfCLU in the next transformation during the whole one-by-one transformation.

After the tenth transformation in FIG. 7, the relation between the raw measured data and the range clusters rngCLU1˜rngCLU5 are collected in Table 6. Please refer to Table 6 showing the cluster data obtained from the one-by-one transformation in FIG. 7.

TABLE 6

| Product(m) | Cluster # of range cluster rngCLU |
|---|---|
| 1 | 1 |
| 2 | 1 |
| 3 | 2 |
| 4 | 3 |
| 5 | 2 |
| 6 | 5 |
| 7 | 4 |
| 8 | 5 |
| 9 | 5 |
| 10 | 1 |

Further, the cluster parameters of the range clusters rngCLU1˜rngCLU15 obtained after the tenth transformation in FIG. 7 are collected in Table 7. Please refer to Table 7 showing the metadata corresponding to the range clusters rngCLU1˜rngCLU5 obtained from the one-by-one transformation in FIG. 7.

TABLE 7

| | | Min. of | Max. of | Acc. sum of | Number of |
|---|---|---|---|---|---|
| Cluster | Range | measDAT | measDAT | measDAT | products |
| # | cluster | in rngCLU | in rngCLU | in rngCLU | in rngCLU |
| 1 | rngCLU1 = | 5.84 | 5.853 | 17.546 | 3 |
| | ptfCLU₁₁₀ | | | | |
| 2 | rngCLU2 = | 5.914 | 5.954 | 11.868 | 2 |
| | ptfCLU₂₁₀ | | | | |
| 3 | rngCLU3 = | 6.482 | 6.482 | 6.482 | 1 |
| | ptfCLU₃₁₀ | | | | |
| 4 | rngCLU4 = | 6.954 | 6.954 | 6.954 | 1 |
| | ptfCLU₄₁₀ | | | | |
| 5 | rngCLU5 = | 7.853 | 7.914 | 23.681 | 3 |
| | ptfCLU₅₁₀ | | | | |

As shown in FIG. 7, after the tenth transformation, the sequence of the value ranges of the range clusters rngCLU1˜rngCLU5 is identical to the sequence of the range cluster numbers wherein both are sorted in ascending order.

In the one-by-one transformation in FIG. 7, the steps of determining the range cluster ptfCLU for receiving the current raw measured data and dynamically adjusting the value ranges of the range clusters ptfCLU in response to the current raw measured data will be described with reference to FIG. 8. FIG. 8 is a flowchart showing that the data transformation device 215 executes the process of obtaining the range clusters ptfCLU on the one-by-one input basis. Please refer to both FIGS. 7 and 8.

At first, the product number m is initialized (m=1) (step S501). Then, a determination is made to judge whether m is smaller than or equivalent to the total cluster number (m≤cluN?) (step S503). For example, in FIG. 7, when the first raw measured data measDAT(m, n) is inputted, the determination result in step S503 is “yes”.

If the determination result in step S503 is “yes”, the number of inputted raw measured data does not reach the total cluster number cluN. At this time, each range cluster ptfCLU corresponds to at most one value. Therefore, the raw measured data measDAT(m. n) of the mth product is treated as a new range cluster ptfCLU (step S505). The occupied range clusters ptfCLU are sorted according to the raw measured data corresponding to the range clusters ptfCLU (step S507). At this time, each range cluster ptfCLU corresponds to a single value of the raw measured data at most. Hence, calculation about the cluster parameters (for example, average, maximum, minimum, and so on) of the range clusters ptfCLU is omitted.

For example, the total cluster number is set to 5 (cluN=5) in FIG. 7. The determination result in step S503 is “yes” during the second to fifth transformation. The raw measured data measDAT(m, n) are directly classified under corresponding range clusters ptfCLU according to the values of the raw measured data measDAT(m, n) (steps S505 and S507).

If the determination result in step S503 is “no”, two conditions may be involved. For example, as shown in FIG. 7, the determination result in step S503 is “no” during the sixth to tenth transformation. At this time, the current raw measured data measDAT(m, n) can not be treated as a new range cluster ptfCLU directly. Instead, the raw measured data should be compared with the value ranges of the range clusters ptfCLU so as to be classified under a proper range cluster ptfCLU (step S511). Alternatively, two range clusters ptfCLU are merged to form a range cluster ptfCLU with a larger value range, and the new non-occupied range cluster ptfCLU is set to correspond to the current raw measured data measDAT(m, n) (steps S513 and S515).

Therefore, if the determination in step S503 is “no”, another determination is made to judge whether the current raw measured data measDAT(m, n) of the mth product can be classified under any range cluster ptfCLU (step S509). If the determination in step S509 is “yes”, it means that the current raw measured data measDAT(m, n) can be classified under one range cluster. For example, as shown in FIG. 7, each raw measured data measDAT(m, n) inputted in the eighth to tenth transformation can be classified under one range cluster ptfCLU directly. Hence, the raw measured data measDAT(m, n) of the mth product is classified under a corresponding range cluster ptfCLU, and the cluster parameters of the corresponding range cluster ptfCLU are modified and updated (step S511).

If the determination result in step S509 is “no”, it means the current raw measured data measDAT(m, n) can not be classified under any occupied range cluster ptfCLU. For example, the current raw measured data measDAT(m, n) is too large or small to be covered by the value ranges of the occupied range clusters ptfCLU. On the other hand, the raw measured data measDAT(m, n) falls in the difference between two adjacent range clusters ptfCLU. In this condition, two adjacent range clusters ptfCLU will be merged to provide a merged range cluster and an unoccupied range cluster, and the cluster parameters of the merged range cluster ptfCLU are recorded (step S513). Also, the raw measured data measDAT(m, n) of the mth product is classified under the unoccupied range cluster ptfCLU whose cluster parameters are further recorded (step S515). For example, in the sixth and seventh transformation in FIG. 7, the raw measured data measDAT(6, n) and measDAT(7, n) can not be directly classified into the five occupied range clusters ptfCLU. Thus, the value ranges of the occupied range clusters ptfCLU should be adjusted.

Step S519 follows steps S507, S511, and S515 to determine whether all of the raw measured data measDAT(1˜M, n) of the M products PDT_M have gone through the cluster transformation (step S519). If the determination result in step S519 is “yes”, the process ends. Otherwise, the product number m counts up (m++) (step S517), and the process returns to step S503 to perform the above-described determination on the raw measured data measDAT(m, n).

Please refer to FIG. 9, which is a schematic diagram showing the process of obtaining the range clusters ptfCLU of exemplified raw measured data on a batch input basis.

Tables 8A, 8B, and 8C show the metadata at different stages. Table 8A shows that the metadata are sorted and have not been divided into clusters, Table 8B shows the metadata after the first dividing stage, and Table 8C shows the metadata after the second dividing stage. In Tables 8B and 8C, the metadata are arranged according to the cluster number of each range cluster tfstgCLU in ascending order, with listing the minimum of the raw measured data, the maximum of the raw measured data, the accumulated summation of the raw measured data and the number of the products corresponding to each range cluster tfstgCLU. In Tables 8A, 8B, and 8C, the cluster numbers of the range clusters tfstgCLU, the minimum of the raw measured data, and the maximum of the raw measured data are arranged in ascending order at all stages.

Please refer to Table 8A showing the metadata before the cluster transformation in FIG. 9.

TABLE 8A

| | Min. of | Max. of | Acc. sum of | Number of |
|---|---|---|---|---|
| Initial | measDAT in | measDAT in | measDAT in | products in |
| cluster | initial cluster | initial cluster | initial cluster | initial cluster |
| initCLU | 5.84 | 7.914 | 66.531 | 10 |

It can be thought that there is only one range cluster tfstgCLU before the cluster transformation, that is, the initial cluster initCLU={5.84, 5.853, 5.853, 5.914, 5.954, 6.482, 6.954, 7.853, 7.914, 7.914}. Accordingly, the minimum of the raw measured data included in the initial cluster initCLU is 5.84, and so is the minimum of all of the raw measured data measDAT(1˜M, n). Similarly, the maximum of the raw measured data included in the initial cluster initCLU is 7.914, and so is the maximum of all of the raw measured data measDAT(1˜M, n). Further, the accumulated summation of the raw measured data measDAT(1˜M, n) included in the initial cluster initCLU is the sum of all of the raw measured data measDAT(1˜M, n). The number of the products corresponding to the initial cluster initCLU is the number (M) of the products PDT_M.

At first, a first-stage intermediate value MIDN1 is defined as an average of the maximum initCLU_max (7.914) and the minimum initCLU_min (5.84) of the raw measured data included in the initial cluster initCLU, that is, MIDN1=(initCLU_max+initCLU_min)/2=(5.84+7.914)/2=6.877. Subsequently, the raw measured data included in the initial cluster initCLU are divided (grouped) according to the first-stage intermediate value MIDN1 to obtain a first first-stage range cluster tfstgCLU₁₁={5.84, 5.853, 5.853, 5.914, 5.954, 6.482} and a second first-stage range cluster tfstgCLU₂₁={6.954, 7.853, 7.914, 7.914}.

Please refer to Table 8B showing the metadata after the first dividing stage of the cluster transformation in FIG. 9.

TABLE 8B

| | | Min. of | Max. of | Acc. sum of | Number of |
|---|---|---|---|---|---|
| | | measDAT | measDAT | measDAT | products |
| Cluster | Range | in range | in range | in range | in range |
| # | cluster | cluster | cluster | cluster | cluster |
| 1 | tfstgCLU₁₁ | 5.84 | 6.482 | 35.896 | 6 |
| 2 | tfstgCLU₂₁ | 6.954 | 7.914 | 30.635 | 4 |

At the second dividing stage, the data transformation device 215 further divides the two first-stage range clusters tfstgCLU₁₁ and tfstgCLU₂₁ according to the intermediate values of the first-stage range clusters tfstgCLU₁₁ and tfstgCLU₂₁.

The data transformation device 215 divides the first first-stage range cluster tfstgCLU₁₁={5.84,5.853, 5.853, 5.914, 5.954, 6.482}. At first, a first second-stage intermediate value MIDN12 is defined as an average of the maximum tfstgCLU₁₁_max (6.482) and the minimum tfstgCLU₁₁_min (5.84) of the raw measured data included in the first first-stage range cluster tfstgCLU₁₁, that is, MIDN12=(tfstgCLU₁₁_max+tfstgCLU₁₁_min)/2=(5.84+6.482)/2=6.161. Subsequently, the first first-stage range cluster tfstgCLU₁₁ is divided according to the first second-stage intermediate value MIDN12 to obtain a first second-stage range cluster tfstgCLU₁₂={5.84, 5.853, 5.853, 5.914, 5.954} and a second second-stage range cluster tfstgCLU₂₂={6.482}.

At the second dividing stage, the data transformation device 215 also divides the second first-stage range cluster tfstgCLU₂₁={6.954, 7.853, 7.914, 7.914}. At first, a second second-stage intermediate value MIDN22 is defined as an average of the maximum tfstgCLU₂₁_max (7.914) and the minimum tfstgCLU₂₁_min (6.954) of the raw measured data included in the second first-stage range cluster tfstgCLU₂₁, that is, MIDN22=(ffstgCLU₂₁_max+tfstgCLU₂₁_min)/2=(6.954+7.914)/2=7.434. Subsequently, the second first-stage range cluster tfstgCLU₂₁ is divided according to the second second-stage intermediate value MIDN22 to obtain a third second-stage range cluster tfstgCLU₃₂={6.954} and a fourth second-stage range cluster tfstgCLU₄₂={7.853, 7.914, 7.914}.

To give a concise description, the data transformation device 215 only performs two dividing stages in the embodiment to generate four second-stage ranger clusters (tfstgCLU₁₂, tfstgCLU₂₂, tfstgCLU₃₂, tfstgCLU₄₂) called the range cluster rngCLU1˜rngCLU4. Please refer to Table 8C showing the metadata obtained after the cluster transformation in FIG. 9.

TABLE 8C

| | | Min. of | Max. of | Acc. sum of | Number of |
|---|---|---|---|---|---|
| | | measDAT | measDAT | measDAT | products |
| Cluster | Range | in range | in range | in range | in range |
| # | cluster | cluster | cluster | cluster | cluster |
| 1 | rngCLU1 = | 5.84 | 5.954 | 29.414 | 5 |
| | tfstgCLU₁₂ | | | | |
| 2 | rngCLU2 = | 6.482 | 6.482 | 6.482 | 1 |
| | tfstgCLU₂₂ | | | | |
| 3 | rngCLU3 = | 6.954 | 6.954 | 6.954 | 1 |
| | tfstgCLU₃₂ | | | | |
| 4 | rngCLU4 = | 7.853 | 7.914 | 23.681 | 3 |
| | tfstgCLU₄₂ | | | | |

In addition to the metadata listed in Table 8C, the data transformation device 215 further generates the cluster data as shown in Table 9. Please refer to Table 9 showing the raw measured data inputted on the batch input basis and the cluster data obtained from the cluster transformation based on value ranges.

TABLE 9

| Product(m) | Cluster # |
|---|---|
| 1 | 1 |
| 2 | 1 |
| 3 | 1 |
| 4 | 2 |
| 5 | 1 |
| 6 | 4 |
| 7 | 3 |
| 8 | 4 |
| 9 | 4 |
| 10 | 1 |

In the above description, a range cluster tfstgCLU is divided according to the intermediate value of the raw measured data included in the range cluster tfstgCLU. In actual practice, the range cluster tfstgCLU may be divided according to another representative value, for example, an average of the raw measured data included in the range cluster tfstgCLU.

Now, the embodiment in FIG. 9 will be illustrated with reference to FIG. 10 to explain the transformation of the raw measured data on the batch input basis by defining the range cluster tfstgCLU based on value ranges. Please refer to FIG. 10, which is a flowchart showing that the data transformation device executes the process of obtaining the range clusters ptfCLU on a batch input basis.

At first, the raw measured data measDAT(1˜M, n) of the products PDT_M are sorted in ascending order (step S601). The sorted raw measured data (initial cluster initCLU) are divided according to the intermediate value on the batch input and transformation basis (step S603).

Subsequently, a determination is made to judge whether the range clusters tfstgCLU obtained from the batch transformation have uneven distribution (step S605). The term “uneven distribution” is defined as that some range clusters tfstgCLU correspond to much more products than other range clusters tfstgCLU. If the determination result in step S605 is “no”, the range clusters tfstgCLU are transformed according to the intermediate values through batch transformation (step S613).

Otherwise, if the determination result in step S605 is “yes”, the batch transformation is performed to divide the much larger range clusters (concentrated distribution) according to the immediate values (step S609) rather than the much smaller range clusters (sparse distribution) (step S607).

After steps S609 and S613, a determination is made to judge whether the number of the range clusters tfstgCLU is smaller than the total cluster number cluN (step S611). If the determination result in step S611 is “no”, the process ends. If the determination result in step S611 is “yes”, the process goes to step S605 to perform the next dividing stage.

In actual practice, different total cluster numbers cluN can be set for the raw measured data on the batch input basis. For example, the total cluster numbers cluN are set to 80, 100, and 120. The cluster transformation is performed relative to the total cluster numbers cluN, respectively, to obtain three sets of cluster data, including the cluster data cluDAT_A and the metadata metaDAT_A corresponding to the first total cluster number cluN=80; the cluster data cluDAT_B and the metadata metaDAT_B corresponding to the second total cluster number cluN=100; and the cluster data cluDAT_C and the metadata metaDAT_C corresponding to the third total cluster number cluN=120. The data transformation device 215 may perform cluster analysis on the cluster data cluDAT_A, cluDAT_B, cluDAT_C, and the metadata metaDAT_A, metaDAT_B, metaDAT_C to analyze the statistical dispersion. The statistical dispersion could be based on the median, the interquartile range (IQR), the mean absolute percentage error (MAPE), or the mean arctangent absolute percentage error (MAAPE). The MAAPE, compared with the MAPE, can observe the statistical dispersion of the data distribution with low bias. The present disclosure does not limit the basis for the cluster analysis.

If the lowest MAAPE corresponds to the total cluster number cluN=100, the raw measured data measDAT(1˜M, n) are divided into 100 range clusters rngCLU. Furthermore, on the condition that the total cluster number cluN is fixed, the intermediate values could be adjusted dynamically at different dividing stages according to the data distribution of the raw measured data.

If the determination result in step S605 is “yes”, the step of dividing the range clusters tfstgCLU according to the intermediate values results in some larger range clusters tfstgCLU having too much raw measured data and some smaller range clusters tfstgCLU having too less raw measured data. At this time, the dividing action will be performed on the larger range clusters tfstgCLU having more raw measured data rather than the smaller range clusters tfstgCLU having less raw measured data. For example, a distribution plot of each range cluster tfstgCLU is provided. If the raw measured data included in one range cluster tfstgCLU seriously deviate from the normal distribution, it is known that the raw measured data included in the range cluster tfstgCLU are not distributed normally.

For solving the problem of uneven distribution of the raw measured data measDAT(1˜M, n), the clusters tfstgCLU could be generated by agglomerative hierarchical clustering in any dividing stage. In another embodiment, a cluster ratio could be used. For example, there are 100,000 raw measured data and 100 range clusters (cluN=100), the cluster ratio is 1/100(=1/cluN), If the number of the raw measured data included in one range cluster tfstgCLU is less than 100,000/cluN=1,000, the range cluster tfstgCLU stops being divided.

According to the above description, the cluster transformation of the raw measured data measDAT(1, n)˜measDAT(M, n) on the batch input basis can be performed with any known statistical algorithm by considering the data distribution and data quantity of the raw measured data, and detailed description is not given herein. During the cluster transformation based on value ranges, the raw measured data are not completely stored, regardless of the one-by-one input basis or batch input basis. The value range of each range cluster rngCLU may cover multiple raw measured data. Therefore, the cluster transformation has distortion. On the contrary, the cluster transformation based on values can restore the raw measured data. Tables 9˜12 show the cluster transformation based on values.

The raw measured data in Table 5 are used for illustrating the cluster transformation based on values. The raw measured data measDAT(1, n)˜measDAT(10, n) and corresponding product numbers are recorded in Table 10.

Please refer to Table 10, listing the raw measured data and the corresponding product numbers.

TABLE 10

| Raw measured data (unsorted) | Product # |
|---|---|
| 5.840 | 1 |
| 5.853 | 2, 10 |
| 5.954 | 3 |
| 6.482 | 4 |
| 5.914 | 5 |
| 7.914 | 6, 9 |
| 6.954 | 7 |
| 7.853 | 8 |

Then, the raw measured data in Table 10 are sorted in ascending order and each of the sorted raw measured data is assigned a cluster number, as shown in Table 11. Please refer to Table 11 showing the sorted raw measured data and corresponding cluster numbers.

TABLE 11

| Raw measured data (sorted) | Product # | Value cluster # (valCLU) |
|---|---|---|
| 5.840 | 1 | 1 |
| 5.853 | 2, 10 | 2 |
| 5.914 | 5 | 3 |
| 5.954 | 3 | 4 |
| 6.482 | 4 | 5 |
| 6.954 | 7 | 6 |
| 7.853 | 8 | 7 |
| 7.914 | 6, 9 | 8 |

Some products have the same raw measured data, and thus only eight raw measured data are listed in Tables 10 and 11. Table 11 lists the raw measured data in ascending order.

In Table 11, each nonrepetitive value of the raw measured data corresponds to a value cluster valCLU. According to the mapping method, each value cluster corresponds to a unique value of the raw measured data instead of the value range. In other words, there is no maximum value and minimum value in each value cluster valCLU during the cluster transformation. The transformation is completely determined by the values of the raw measured data measDAT(1˜M, n), and the total cluster number can not be preset. Therefore, if any two values of the raw measured data measDAT(1˜M, n) are different from each other, there will be M value clusters valCLU, and each value cluster valCLU corresponds to only one product.

Subsequently, the data in Table 11 are arranged in order of the product number to get Tables 12 and 13. Please refer to Table 12 showing the cluster data after the transformation.

TABLE 12

| Product # | Value cluster# (valCLU) |
|---|---|
| 1 | 1 |
| 2 | 2 |
| 3 | 4 |
| 4 | 5 |
| 5 | 3 |
| 6 | 8 |
| 7 | 6 |
| 8 | 7 |
| 9 | 8 |
| 10 | 2 |

Please refer to Table 13 showing the metadata after the transformation.

TABLE 13

| Value cluster | Raw measured | Product | Number of |
|---|---|---|---|
| (valCLU) # | data | # | product(s) |
| 1 | 5.840 | 1 | 1 |
| 2 | 5.853 | 2, 10 | 2 |
| 3 | 5.914 | 5 | 1 |
| 4 | 5.954 | 3 | 1 |
| 5 | 6.482 | 4 | 1 |
| 6 | 6.954 | 7 | 1 |
| 7 | 7.853 | 8 | 1 |
| 8 | 7.914 | 6, 9 | 2 |

The data in Table 13 are arranged in order of the value cluster (valCLU) number, and Table 13 lists the raw measured data, the product number, and the number of the products corresponding to the value clusters valCLU. In table 13, both the value cluster (valCLU) numbers and the raw measured data are arranged in ascending order.

As described above, Tables 10 and 11 show the transition data during the cluster transformation, and these transition data are not stored in the storage space. Only the data in Tables 12 and 13 will be stored in the storage space for training the prediction model predMDL.

Please refer to Tables 3, 12, and 13. In the prior arts, no cluster transformation is performed on the raw measured data measDAT_MN so that the model training device 213 directly uses the raw measured data measDAT_MN in Table 3 to train the prediction model predMDL. According to the present disclosure, the data transformation device 215 performs the cluster transformation so that the model training device 213 uses the data in Tables 12 and 13 to train the prediction model predMDL. The raw measured data in Table 3 are represented by floating-point numbers which require larger storage space, transmission bandwidth, and computation resulting in much time while training the prediction model predMDL. On the other hand, while using the data in Tables 12 and 13 as the input of the prediction model predMDL, the model training device 213 uses the data in Table 12 to train the prediction model predMDL and it is possible to restore the data in Table 13 to the raw measured data measDAT(1, n)˜measDAT(M, n) of the products PDT_M. Compared to the raw measured data in Table 3, the value cluster (valCLU) numbers in Table 12 are represented by integers, and the use of the value cluster (valCLU) numbers can greatly simplify the training procedure of the prediction model predMDL.

In the above description, the present disclosure provides two types of cluster transformation using range clusters rngCLU and one type of cluster transformation using value clusters valCLU. In the description concerning the range clusters rngCLU, M raw measured data are inputted on the one-by-one input basis (FIGS. 7 and 8) or the batch input basis (FIGS. 9 and 10). In actual practice, the raw measured data measDAT_MN could be inputted in a mixed-mode. For example, 80,000 records of the raw measured data go through batch transformation first, and the remained 20,000 records of the raw measured data go through one-by-one transformation according to the clustering result of the 80,000 records of the raw measured data. Further, the data transformation device 215 performs the cluster transformation for each measurement property independently. Therefore, the one-by-one input basis, the batch input basis, or the mixing basis could be adopted for different measurement properties. On the other hand, the transformation related to the value clusters valCLU shown in Tables 10˜13 needs to sort all of the raw measured data measDAT(1˜M, n) and then numbers the value clusters valCLU corresponding to the sorted raw measured data measDAT(1˜M, n). Therefore, the transformation related to the value clusters valCLU is preferably performed after all of the M raw measured data measDAT(1˜M, n) have been inputted.

As described above, the data obtained from the cluster transformation will be used to train the prediction model predMDL. The cluster data obtained from the cluster transformation can speed training the prediction model predMDL. In actual practice, the procedure and architecture of training the prediction model predMDL could vary with the type or characteristics of the products PDT_M, and related details are not given herein. The variables M, N, K, X, n, and k are all positive integers, and n≤N, k≤K, and M<X.

As described above, the present disclosure provides a quality prediction system using a prediction model to predict the product quality without actually detecting the product quality to simplify the quality inspection. The present disclosure proposes the cluster transformation to reduce the amount of data required for training the prediction model predMDL so as to shorten the training procedure of the prediction model predMDL and speed up building the prediction model predMDL. Accordingly, the manufacturer can use the prediction model predMDL to predict the product quality according to the raw measured data measDAT_X of the products PDT_X which are measured during the manufacturing process. The cluster transformation according to the present disclosure used in building the prediction model predMDL can reduce the cost and time of quality inspection.

Although the exemplified products are IC in the embodiments, the present disclosure is not limited to this. In other words, the method of transforming the raw measured data measDAT_MN into the cluster data cluDAT_MN could be widely applied to manufacturing processes of various kinds of products, regardless of adopting range clusters rngCLU or value clusters rngCLU corresponding to the N measurement properties.

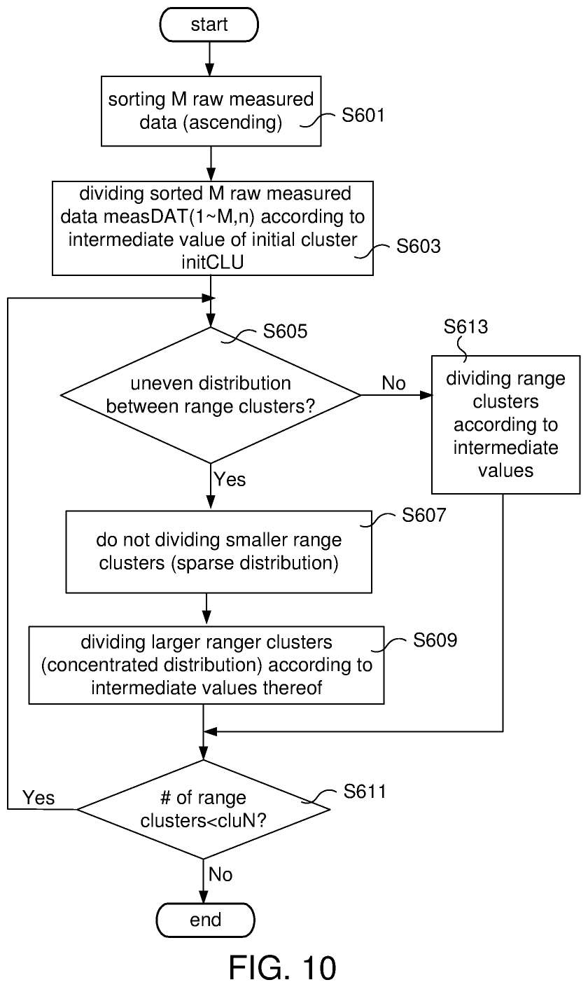

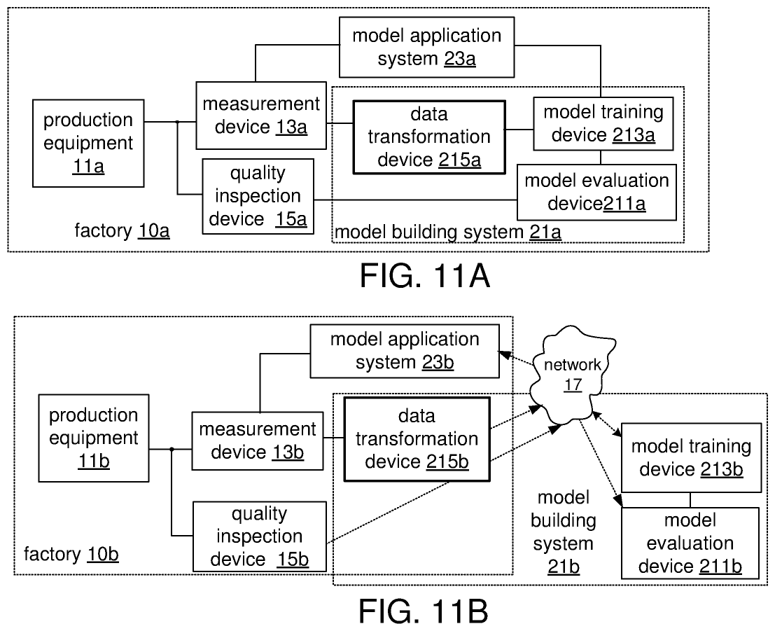

It is to be noted that the installment of the quality prediction system of the present disclosure is flexible to meet different requirements. For example, as shown in FIG. 11A, the quality prediction system is entirely set up in the factory. Alternatively, as shown in FIG. 11B, only a portion of the quality prediction system is set up in the factory. In actual practice, the installment and the relative positions between the internal devices of the quality prediction system are not limited to the embodiments.

Please refer to FIG. 11A, which is a block diagram illustrating the model building system set up in a factory. In FIG. 11A, the model building system 21a and the model application system 23a are set up in the factory 10a. In the factory 10a, the production equipment 11a is electrically coupled to the measurement device 13a and the quality inspection device 15a. In addition, the measurement device 13a is electrically coupled to the data transformation device 215a and the model application system 23a, and the quality inspection device 15a is electrically coupled to the model evaluation device 211a. The model training device 213a is electrically coupled to the model application system 23a, the data transformation device 215a, and the model evaluation device 211.

Please refer to FIG. 11B, which is a block diagram illustrating the model building system having both in-factory arrangement and out-of-factory arrangement. In FIG. 11B, only a portion of the model building system 21b (the data transformation device 215b) and the model application system 23b are set up in the factory 10b. In the factory 10b, the production equipment 11b is electrically coupled to the measurement device 13b and the quality inspection device 15b. Due to the out-of-factory arrangement of the model training device 213b and the model evaluation device 211b, the model application system 23b, the data transformation device 215b, the quality inspection device 15b, the model evaluation device 211b, and the model training device 213b are in communication with a network 17. In this diagram, the model application system 23b is set up in the factory 10b and is more convenient for the manufacturer. Also, to set up the data transformation device 215b in the factory 10b can reduce the data required to be transmitted through the network 17.

To sum up, the arrangement of the quality prediction system is adjustable according to the characteristics of the products, the requirements of the manufacturer, the communication architecture, and so on. A mechanism of sampling inspection is helpful in dynamical modification to the architecture of the prediction model to reduce the time and cost for quality inspection.

It is to be noted that the logic blocks, modules, circuits, and steps of any method described in the embodiments can be implemented by hardware, software, or combination of both. The wording of “in communication with”, “connected to”, “coupled to”, “electrically connected to” or other similar wording is used to indicate direct or indirect signal exchange (for example, cable signals, wireless electromagnetic signals, and optical signals) to achieve transfer and transmission of signals, data or control information to implement the logic blocks, modules, circuits and steps of the method. The wording in the specification does not limit the real connection type, and all known connection types are encompassed in the scope of the present invention.

While the invention has been described by way of example and in terms of the preferred embodiment(s), it is to be understood that the invention is not limited thereto. On the contrary, it is intended to cover various modifications and similar arrangements and procedures, and the scope of the appended claims, therefore, should be accorded the broadest interpretation so as to encompass all such modifications and similar arrangements and procedures.

What is claimed is:

1. A model building system comprising:
a data transformation device for transforming M*N raw measured data comprising N measurement properties of M products into N sets of cluster data and N-dimensional metadata corresponding to the N measurement properties, wherein
the M*N raw measured data comprise first raw measured data corresponding to a first portion of the M products and second raw measured data corresponding to a second portion of the M products,
the N sets of cluster data comprise first cluster data corresponding to the first portion of the M products and second cluster data corresponding to the second portion of the M products, and
M quality inspection results obtained by inspecting the M products comprise first quality inspection results corresponding to the first portion of the M products and second quality inspection results corresponding to the second portion of the M products; and
a model training device, electrically coupled to the data transformation device, for creating a prediction model according to the second cluster data, the second quality inspection results, and the N-dimensional metadata, and modifying a plurality of structural parameters of the prediction model according to the first raw measured data and the first quality inspection results, wherein M and N are positive integers.

2. The model building system according to claim 1, wherein the M products are divided into K sample sets, wherein
the first portion of the M products are M/K products included in a kth sample set of the K sample sets, and
the second portion of the M products are (K−1)*M/K products included in a first to a (k−1)th sample sets and a (k+1)th to a Kth sample sets of the K sample sets,
wherein K and k are positive integers, M is a multiple of K, and k is smaller than or equivalent to K.

3. The model building system according to claim 1, wherein after creating the prediction model, the model training device inputs the first raw measured data to the prediction model, and the prediction model generates quality prediction results corresponding to the first portion of the M products.

4. The model building system according to claim 3, further comprising:
a model evaluation device, electrically coupled to the model training device, for receiving and comparing the first quality inspection results and the quality prediction results to generate and transmit an accuracy result to the prediction model wherein the prediction model modifies the prediction model according to the accuracy result.

5. The model building system according to claim 1, wherein the data transformation device comprises:
N data transformation modules corresponding to the N measurement properties,
wherein a nth set of cluster data of the N sets of cluster data comprise (1, n)˜(M, n) cluster data, and a nth data transformation module of the N data transformation modules performs cluster transformation on (1, n)˜(M, n) raw measured data of the M*N raw measured data corresponding to a nth measurement property to obtain the (1, n)˜(M, n) cluster data, wherein n is a positive integer and n is smaller than or equivalent to N.

6. The model building system according to claim 5, wherein the data transformation device defines a plurality of clusters according to the (1, n)˜(M, n) raw measured data corresponding to the nth measurement property, and determines a plurality of cluster numbers corresponding to the clusters according to values of the (1, n)˜(M, n) raw measured data.

7. The model building system according to claim 6, wherein a number of the clusters is determined according to a total cluster number, and the total cluster number is smaller than M.

8. The model building system according to claim 6, wherein nth dimensional metadata of the N-dimensional metadata comprise a plurality sets of cluster parameters determined according to the cluster numbers.

9. The model building system according to claim 6, wherein each of the cluster numbers represents a value range, and the value range corresponds to at least two of the (1, n)˜(M, n) raw measured data.

10. The model building system according to claim 6, wherein the nth data transformation module classifies the (1, n)˜(M, n) raw measured data under the clusters sequentially, and determines the value ranges of the clusters according to the raw measured data included in the clusters.

11. The model building system according to claim 6, wherein the nth data transformation module divides the (1, n)˜(M, n) raw measured data according to a first-stage intermediate value after receiving the (1, n)˜(M, n) raw measured data to generate a first first-stage range cluster comprising a portion of the (1, n)˜(M, n) raw measured data and a second first-stage range cluster comprising the other portion of the (1, n)˜(M, n) raw measured data, wherein the first-stage intermediate value is determined according to the (1, n)˜(M, n) raw measured data.

12. The model building system according to claim 11, wherein the nth data transformation module divides the portion of the (1, n)˜(M, n) raw measured data according to a first second-stage intermediate value, and divides the other portion of the (1, n)˜(M, n) raw measured data according to a second second-stage intermediate value.

13. The model building system according to claim 6, wherein the N data transformation modules sort the (1, n)˜(M, n) raw measured data after receiving the (1, n)˜(M, n) raw measured data, and determine a plurality of cluster numbers according to the sorted (1, n)˜(M, n) raw measured data.

14. The model building system according to claim 13, wherein each of the cluster numbers corresponds to at least one value of the (1, n)˜(M, n) raw measured data.

15. A quality prediction system comprising:
a model building system for receiving M*N raw measured data comprising N measurement properties of M products, and M quality inspection results corresponding to the M products, the model building system comprising:
a data transformation device for transforming the M*N raw measured data into N sets of cluster data and N-dimensional metadata corresponding to the N measurement properties, wherein
the M*N raw measured data comprise first raw measured data corresponding to a first portion of the M products and second raw measured data corresponding to a second portion of the M products, the N sets of cluster data comprise first cluster data corresponding to the first portion of the M products and second cluster data corresponding to the second portion of the M products, and
the M quality inspection results comprise first quality inspection results corresponding to the first portion of the M products and second quality inspection results corresponding to the second portion of the M products; and
a model training device, electrically coupled to the data transformation device, for creating a prediction model according to the second cluster data, the second quality inspection results, and the N-dimensional metadata, and modifying a plurality of structural parameters of the prediction model according to the first raw measured data and the first quality inspection results; and
a model application device, electrically coupled to the model building system, for receiving the prediction model and X*N raw measured data corresponding to X products and N measurement properties, wherein the model application device receives the prediction model from the model training device after the prediction model is completely trained, and inputs the X*N raw measured data to the prediction model to generate X quality prediction results corresponding to the X products, wherein M, N and X are positive integers and X is greater than M.

16. The quality prediction system according to claim 15, wherein the M products are divided into K sample sets, wherein
the first portion of the M products are M/K products included in a kth sample set of the K sample sets, and
the second portion of the M products are (K−1)*M/K products included in a first to a (k−1)th sample sets and a (k+1)th to a Kth sample sets of the K sample sets,
wherein K and k are positive integers, M is a multiple of K, and k is smaller than or equivalent to K.

17. A quality management system comprising:
at least one measurement device for measuring N measurement properties of M products to generate M*N raw measured data;
a quality inspection device for inspecting the M products to generate M quality inspection results; and
a quality prediction system comprising:
a model building system, electrically coupled to the at least one measurement device and the quality inspection device, for receiving the M*N raw measured data and the M quality inspection results, the model building system comprising:
a data transformation device for transforming the M*N raw measured data into N sets of cluster data and N-dimensional metadata corresponding to the N measurement properties, wherein
the M*N raw measured data comprise first raw measured data corresponding to a first portion of the M products and second raw measured data corresponding to a second portion of the M products,
the N sets of cluster data comprise first cluster data corresponding to the first portion of the M products and second cluster data corresponding to the second portion of the M products, and
the M quality inspection results comprise first quality inspection results corresponding to the first portion of the M products and second quality inspection results corresponding to the second portion of the M products; and
a model training device, electrically coupled to the data transformation device, for creating a prediction model according to the second cluster data, the second quality inspection results, and the N-dimensional metadata, and modifying a plurality of structural parameters of the prediction model according to the first raw measured data and the first quality inspection results; and
a model application device, electrically coupled to the at least one measurement device and the model building system, for receiving the prediction model after the prediction model is completely trained, wherein M and N are positive integers.

18. The quality management system according to claim 17, wherein the at least one measurement device measures the N measurement properties of the X products after the prediction model is completely trained, and the prediction model uses the X*N raw measured data to generate X quality prediction results corresponding to the X products, wherein X is a positive integer, and X is greater than M.

19. The quality management system according to claim 17, wherein the M products are divided into K sample sets, wherein
the first portion of the M products are M/K products included in a kth sample set of the K sample sets, and
the second portion of the M products are (K−1)*M/K products included in a first to a (k−1)th sample sets and a (k+1)th to a Kth sample sets of the K sample sets,
wherein K and k are positive integers, M is a multiple of K, and k is smaller than or equivalent to K.
